(19) United States
(12) Patent Application Publication
(10) Pub. No.: US 2004/0087231 A1
(43) Pub. Date: May 6, 2004

(54) Fiber complex and its use

(76) Inventors: Keiji Nakanishi, Osaka (JP); Shoichiro Noguchi, Osaka (JP)

Correspondence Address: Kirschstein Ottinger Israel & Schiffmiller, 489 Fifth Avenue, New York, NY, 10017-6105, US

(21) Appl. No.: 10/471,993

(22) PCT Filed: Mar. 15, 2002
(86) PCT No.: PCT/JP02/02505

(30) Foreign Application Priority Data
Mar. 15, 2001 (JP) 200173801

(51) Int. Cl. B32B 5/02; B32B 27/02

(52) U.S. Cl. 442/179; 442/110; 442/164; 442/172

(57) ABSTRACT

The present invention relates to a fiber complex where conductive composite fibers having a conductive thermoplastic component and a fiber forming component are mixed, characterized in that the conductive composite fiber is composed of a thermoplastic polymer containing carbon black and has a specific resistance of 10⁶ Ω cm or less, and the conductive thermoplastic component covers 50% or more of the fiber surface and has a structure continuous in the long axis direction of fiber, and working wears, filters and shoe insoles using the fiber complex. ·

The present invention provides fiber products which give good conductivity in a surface resistance measuring method and are excellent in antistaticity and its durability.

### TECHNICAL FIELD

The present invention relates to fiber products mainly used for inhibiting electrostatic charge. ·

### BACKGROUND ART

Cloths consisting of synthetic fibers have been used in various fields as they are generally more excellent in strength and durability than cloths consisting of natural fibers. However, they have a disadvantage of being easily charged. Recently, as the products in the fields of medical products, medicines, foods, electronic devices and precision machineries gain high performance, it has become clear that air dust exerts a great influence on the performance of the products. Thus, when a cloth on which dust is adsorbed by electrostatic charge is brought into a production environment, the efficiency of the production may be consequently lowered. In addition, dangerous sparking may occur by static electricity in an environment easily forming fire and explosion. Therefore, fiber products using cloths treated with an antistatic treatment have become essential in various production sites. ·

Practically, dustproof wears and shoe inner layers consisting of clothes treated with an antistatic treatment are used for example in working wears and working shoes in a clean room, because improvement in product yield can be anticipated by inhibiting static electricity accumulated on clothes and human body to prevent destruction of minute circuit caused by discharge and by inhibiting adsorption of dust on clothes and human body by static electricity to shut dust out of the clean room. Also, cloths treated with an antistatic treatment are highly useful as filter materials, because they can prevent static electricity generated by friction of liquid or gas having inflammability with the filter during filtration to avoid ignition and explosion.

Conventionally, various methods have been conceived as applying antistatic efficiencies to cloths. For example, popular are a method of adhering a surface active agent on the surface of a cloth by after-teatment and a method of constituting a cloth by antistatic fibers in which a hydrophilic polymer is incorporated. However, these cloths are low in wash resistance and insufficient in antistaticity under low humidity. Thus, cloths in which conductive fibers are incorporated at a given ratio are usually used.

As the conductive fiber, a conductive composite fiber containing a conductive component consisting of conductive particles and a thermoplastic component as the core component (island component) and a fiber-forming component as the sheath component (sea component) is common from the aspect of processability and wash resistance.

Recently, mainly in Europe and United States, a method of measuring the resistance between two electrodes by attaching the electrodes at two spots on the surface of a fiber product (hereafter called surface resistance measuring method) has been generalized as means for evaluating the antistaticity of a fiber product without destroying it. This method has a problem the product is judged to be poor in antistaticity as the conductivity is shown to be low at the cloth surface, because the conductive component is not contacted to the electrode when the area of the conductive component exposed to the conductive fiber surface incorporated to the fiber product is small in spite of the actual product has a sufficient antistaticity. ·

JP 11-350296 A proposes a cloth of improved contact between conductive yarns to improve conductivity, in which the used conductive yarns are made by covering a synthetic filament yarn as a core with a conductive composite fiber. However, when the conductive component is lowly exposed to the fiber surface, the conductive component cannot contact with itself or with the electrode and hence a good conductivity cannot be attained in the surface resistance measuring method unless a conductive adhesive having permeability for lowering contact resistance is used.

It can be easily thought it is enough to use a conductive component as the surface layer to eliminate the disadvantage and various proposals have been made for it. For example, a method has been proposed in which a conductive component prepared by dispersing a metal component such as titanium oxide and cuprous iodide and conductive carbon particles is coated on the surface. However, the conductive fiber prepared by the method has no wash resistance and, though it has high conductivity in initial stage, the conductive component is pealed off and fell off by repeated washing to lower conductivity and also to cause enhanced self dusting and thus it is difficult to be used as dustproof clothes used in clean room requiring indispensably repeated washing. ·

The object of the present invention is to provide fiber products exhibiting good conductivity in the surface resistance measuring method and excellent antistaticity and durability. ·

### DISCLOSURE OF THE INVENTION·

The present invention relates to a fiber complex where conductive composite fibers having a conductive thermoplastic component and a fiber-forming component are mixed, characterized in that the conductive composite fiber is composed of a thermoplastic polymer containing carbon black and has a specific resistance of 10⁶·Ω cm or less, and the conductive thermoplastic component covers 50% or more of the fiber surface and has a structure continuous in the long axis direction of fiber. ·

Also, as a preferred embodiment of the present invention, exemplified is a fiber complex containing 0.1 to 15 weight % of the conductive composite fiber. Furthermore, concrete uses of the fiber complex of the present invention include dustproof clothes, shoe inner layers and filters.

### BRIEF DESCRIPTION OF DRAWINGS

FIG. 1 is a cross section of an example of conductive composite fiber used in the fiber complex according to the present invention. ·

FIG. 2 is a cross section of an example of conductive composite fiber used in the fiber complex according to the present invention.

FIG. 3 is a cross section of an example of conductive composite fiber used in the fiber complex according to the present invention.

FIG. 4 is a cross section of an example of conductive composite fiber used in a fiber complex out of the scope of the present invention.

FIG. 5 is a cross section of an example of conductive composite fiber used in a fiber complex out of the scope of the present invention. ·

The numerals will be explained as follows.

1 shows a conductive component. ·

2 shows a nonconductive component.

### BEST EMBODIMENT OF THE INVENTION

The conductive composite fiber used in the present invention will be illustrated. ·

As the thermoplastic polymer used in the conductive and nonconductive components of the conductive composite fiber used in the present invention, various known thermoplastic polymers having fiber-forming ability such as polyesters, polyamides, polyolefins and copolymers thereof can be used and it can be properly selected. Particularly, it is preferred the thermoplastic polymer is of the same sort as the fiber material of the base yarns accounting for most of the cloth mixed with the conductive composite fibers to reduce the necessity of special notice in the later steps such as dyeing.

Also, the thermoplastic polymers used in the conductive component and the nonconductive component are preferably thermoplastic polymers of same sort from the viewpoint of adhesion between both components. Even when both thermoplastic polymers are different from each other, the adhesion can be improved by mixing a solubilizer to both or one of the components in some cases. For example, the adhesion can be improved by mixing a small quantity of a maleic acid-modified polyolefin as a solubilizer to the polyolefin side in the case of a polyamide and a polyolefin. ·

The conductive component is constituted by a mixture prepared by mixing uniformly conductive carbon black in a thermoplastic polymer according to a usual method. The mixing ratio of conductive carbon black is different in compliance with the sorts of the polymer and carbon black used, but it is preferred to be usually 10 to 50 weight %, particularly 15 to 40 weight %. ·

The conductivity of the conductive composite fiber used in the present invention is required to be such that the specific resistance is 10⁶·Ω or less. When the specific resistance is out of the range, the self discharging ability of the conductive fiber is not expressed and it is not useful for the antistatic measure of the fiber complex. It is preferably about 10⁴ Ω or less and most preferably 10² Ω or less. ·

Various additives such as dispersants (waxes, polyalkylene oxides, various surface active agents, organic electrolytes, etc.), coloring agents, heat stabilizers (antioxidants, UV absorbers, etc.), fluidity improvers and fluorescent whiteners can be added to the conductive component and the nonconductive component if required. ·

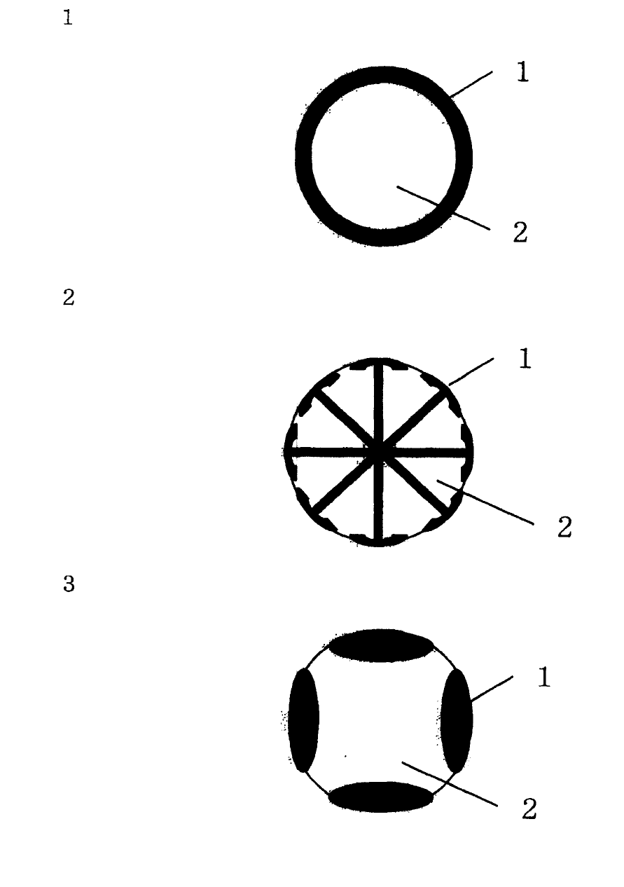

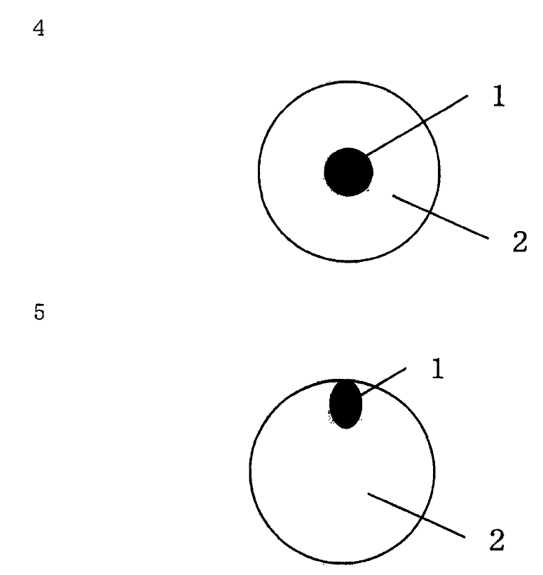

The composite form of the conductive composite fiber used in the present invention is not especially restricted. However, at least 50% of the fiber surface shall be covered by the conductive component. Examples of section form are shown in FIGS. 1 to 3 where 4 to 8 pieces of the conductive component are arranged on the fiber surface. By utilizing a conductive composite fibers of such structures, contact between the conductive components of each conductive fibers and contact between the conductive component and the electrode of the measuring device are improved to give good conductivity in the surface resistance measuring method. For the primary purpose, a higher exposure of the conductive component to the fiber surface is preferable. However, it is of high technical difficulty to cover it completely as the melt fluidity of the conductive component is remarkably lowered by being mixed with conductive carbon black. Also, it can be judged they contact each other sufficiently as seen from the electrode size of the measuring device used in the surface resistance measuring method and the fiber size of the composite fiber. Thus, it can be said the purpose can be attained when at least 50% of the fiber surface is covered. ·

The composite ratio of the conductive component to the nonconductive component is preferably 1:20 to 2:1 by volume. From viewpoint of ensuring the fiber property, a higher ratio of the nonconductive component is preferred. However, a lower ratio of the conductive component makes it difficult to give a stable composite form and thus gives poor stability in conductivity. Therefore, taking it in consideration, it is preferred the ratio is 1:20 to 2:1 and more preferably the ratio is 1:15 to 1:1. ·

The conductive composite fiber used in the present invention is essentially prepared by melt composite spinning method. For example, a composite fiber in which a similar composite form is formed by an after treatment such as coating has poor durability and the conductive component is pealed off and fell off when repeatedly washed. By being prepared by melt composite spinning method, a sufficient durability can be attained even in a use requiring repeated washing such as dustpoof clothes used in clean room and so.

In the fiber complex of the present invention, another fiber (called “nonconductive fibers” hereinafter) is mixed to the said conductive fiber for use. Various fibers can be used as the other fiber mixed to the conductive composite fiber. For example, synthetic fibers such as nylon, polyester and acrylic and natural fibers such as cotton, silk and wool are exemplified. A mixture of a plural of fibers can be also used. Among them, a synthetic fiber can be preferably used when taking the use of the fiber complex in consideration·. Because synthetic fibers are higher in strength and durability than natural fibers. ·

The mixing method of the conductive fibers and the nonconductive fibers is not particularly restricted. For example, conductive composite fibers can be driven at a given interval to a woven or a knitted good as a single material or they can be driven to a cloth by doubling or doubling and twisting with nonconductive fibers in compliance with its fineness. Also, they can be blended with other short fibers after cut to a given length or they can be sewed to an established cloth. ·

The amount of the conductive composite fibers used in the fiber complex of the present invention is preferably 0.1 to 15 weight %. When the ratio of the conductive composite fibers is 0.1 weight % or less, antistatic effect due to corona discharge is insufficient and hence adsorption of dust to human body and wears by static electricity cannot be prevented. When the ratio exceeds 15 weight %, the antistatic effect of the fiber complex is almost saturated and increases the cost and lowers the processability unfavorably.

A dustproof cloth of the present invention is constituted by woven or knitted goods of the said fiber complex. The base yarns are preferably filament yarns from the viewpoint of inhibiting dust formation of the cloth itself. When spun yarns are used, it is preferred to prevent self dusting by laminating and so.

Though the texture of the cloth is not especially restricted, it is preferred to be of high density from the viewpoint of inhibiting dust permeation. However, a higher density gives poorer wearing feel and hence the texture and the density shall be set according to the purpose. Furthermore, if required, fineness can be enhanced by pressing the cloth by calendering and so and a fiber having water-absorbing and rapidly drying property for improving wearing feel and antibacterial performance and various functional fibers such as antistatic fiber promoting rapid decrease in static voltage of the cloth can be also used together. ·

By using the dustproof cloth of the present invention, static electricity accumulated in the cloth in any environment can be inhibited to prevent destruction of minute circuit caused by discharge and adsorption of dust caused by static electricity can be inhibited to improve the yield of the product shutting dust out of clean room. Also, by measuring the surface resistance of the product, the antistaticity can be presumed and thus simple quality control can be performed with no destruction of the product. ·

The shoe inner layer of the present invention is constituted of a woven good of the said fiber complex and a nonwoven fabric. Though polyamide excellent in abrasion resistance is mainly used as the nonconductive fiber, it is not particularly restricted. By using a heat adhesive fiber and a composite fiber containing a low-melting polymer at the sheath portion, point adhesion processing can be performed to maintain stereo structure and to relieve impact. ·

When the conductive composite fiber of the present invention is used as a nonwoven fabric, the single yarn fineness is preferably 8 decitex or less. Because, when the single yarn fineness becomes small, the number of yarns is increased even at a same weight ratio and the probability of mutual contact between conductive composite fibers is increased and thus the conductivity in the direction along the cloth surface (horizontal direction) and vertical direction is improved.

By using the shoe inner layer of the present invention, it is a matter of course that the inner layer itself is made to be antistatic and static electricity accumulated in human body can be leaked to the earth through the inner layer and the sole when a conductive resin is used at the sole portion of the shoes. As the result, improvement of work efficiency in clean room can be expected in the same manner as in dustproof cloth.

The filter of the present invention is constituted of a woven good of the fiber complex and a nonwoven fabric. In the same manner as for shoe inner layer, by using a heat adhesive fiber and a composite fiber containing a low-melting polymer at the sheath portion, point adhesion processing can be performed to maintain stereo structure and to improve dimensional stability. Also, in the same manner as in shoe inner layer, it is preferable the single yarn fineness is smaller when used as a nonwoven fabric.

By using the filter of the present invention, static electricity generated by friction of an inflammable liquid or gas with the filter can be inhibited when the liquid or the gas is filtered at high speed to avoid ignition and explosion. Also, the filtration rate can be set high to improve productivity.

### EXAMPLES

Now, the present invention will be practically described according to Examples. Here, the measurements and evaluations of various properties in the following Examples have been carried out by the following method.

The conductivity of a conductive composite fiber was evaluated by a procedure in which a sample was prepared by cutting the fiber to 10 cm long and its both ends were adhered to a metal terminal with a conductive adhesive and a direct current voltage of 1000 V was applied to it and the resistance was measured and it was converted to the specific resistance. ·

The surface resistance of the cloth was measured by using Megaohm Meter Model 800 made by ACL Staticide Co. at a parallel electrode width of 7.5 cm and a distance between the electrodes of 7.5 cm. Here, a sample previously moisturized at 20° C. under 30% RH was used for the measurement.

The antistaticity of the cloth was measured by a procedure in which the initial static voltage was measured by using a sample moisturized at 20° C. under 30% RH according to the friction charge attenuation measuring method JIS L 1094.

Wash resistance was measured for durability. 100 times washings were carried out by JIS L 0217 E 103 method and the conductivity of the conductive composite fiber and the surface resistance of the cloth were measured before and after washing.

The covering rate of the conductive component on fiber surface was evaluated by a procedure in which 20 section photographs of yarns were taken with an optical microscope made by Olympus Optical Co. at optional intervals and measured by an image analytical equipment made by Keyence Corp and the average value was checked.

### Examples 1 to 3, Comparative Examples 1 and 2·

A conductive polymer prepared by dispersing conductive carbon black to 25 weight % in polyethylene terephthalate in which 12 mol % of isophthalic acid was copolymerized was used as the conductive component and a homopolyethylene terephthalate was used as the nonconductive component. They were composed in several composite ratios and composite structures, spun at 285° C., wound at a rate of 1000 m/min while cooling and oiling, further drawn on a draw roller at 100·° C. and heat-treated on a hot plate at 140·° C., and wound to prepare conductive composite fibers Y1 to Y4. The conductivitys and the covering rates of conductive component on fiber surface of Y1 to Y4 are shown in Table 1.

TABLE 1

| | Y1 | Y2 | Y3 | Y4 |
|---|---|---|---|---|
| Composite structure | | | | |
| Composite ratio | 1:6 | 1:8 | 1:8 | 1:8 |
| Dtex/f | 84/12 | 22/6 | 22/6 | 22/6 |
| Conductivity Ω · cm | 4.7 × 10¹ | 5.5 × 10¹ | 6.8 × 10¹ | 1.3 × 10² |
| Covering rate | 100% | 100% | 67% | 0% |

Polyester filament yarn of 84 decitex/72 filaments was used as the warp and weft forming the ground part and Y1 as the conductive yarns was used at each warp and weft interval of 5 mm to prepare a plain weave. The woven fabric was processed by a usual method to give Cloth 1.

Cloths 2 to 4 were prepared with same constitution as Cloth 1 except that the following conductive twisted yarns were used as a contductive yarn instead of Y1; The twisted yarns were made by twisting Y2 to Y4 with a Polyester filament yarn of 56 decitex/24 filaments at a twisting number of 250 T/m.

Also, as Comparative Example, Cloth 5 of the same constitution as Cloths 2 to 4 was prepared by using a conductive fiber Y5 prepared by coating the periphery of Nylon monofilament 22 decitex with a carbon black-containing resin. The conductivity of the original yarn of Y5 was as good as 2.2·×10⁰·Ω·cm. Mixing rates of conductive fiber in Cloths 1 to 5 and various properties are shown in Table 2. ·

TABLE 2

| | | | | Comp. | Comp. |
|---|---|---|---|---|---|
| | Example 1 | Example 2 | Example 3 | Ex. 1 | Ex. 2 |
| Conductive | Y1 | Y2 | Y3 | Y4 | Y5 |
| yarn used | | | | | |
| Mixing ratio | 8.3% | 2.2% | 2.2% | 2.2% | 2.4% |
| Initial | | | | | |
| Surface | 5.6 × 10⁶ | 9.8 × 10⁶ | 1.7 × 10⁷ | 2.1 × 10¹⁵ | 6.6 × 10⁵ |
| resistance Ω | | | | | |
| Antistaticity | 1,600 | 1,890 | 2,080 | 3,300 | 1,800 |
| V | | | | | |
| After 100 | | | | | |
| washings | | | | | |
| Surface | 7.1 × 10⁶ | 8.7 × 10⁶ | 3.3 × 10⁷ | 9.2 × 10¹⁴ | 4.5 × 10¹⁴ |
| resistance Ω | | | | | |
| Antistaticity | 1,910 | 1,850 | 1,900 | 3,020 | 15,900 |
| V | | | | | |

As apparent from Table 2, Y4 where the conductive component was not exposed on the surface showed no effect in surface resistance measurement, though washing resistance was observed. In the case of Y5, the conductive component was peeled off and fell off by 100 washings to eliminate most of conductivity and antistaticity though exerting performances equivalent to or higher than that of the present invention. Contrary to it, the present invention gave good results in surface resistance and its durability. ·

Equivalent results to the evaluation of cloths were obtained when dustproof wears prepared by using these cloths and they were evaluated practically. ·

### Examples 4 and 5, Comparative Example 3

A conductive polymer prepared by dispersing conductive carbon black to 35 weight % in Nylon 6 was used as the conductive component and Nylon 6 was used as the nonconductive component. They were composed in several composite ratios and composite structures and spun at 275° C. and wound at a rate of 800 m/min while cooling and oiling and further drawn on a draw roller at 80·° C. and heat-treated on a hot plate at 140·° C. and wound to prepare conductive composite fibers Y6 to Y8 of 330 decitex/100 filaments. The conductivity and the covering rate of conductive component on fiber surface of Y6 to Y8 are shown in Table 3. ·

TABLE 3

| | Y6 | Y7 | Y8 |
|---|---|---|---|
| Composite structure | | | |
| Composite ratio | 1:8 | 1:15 | 1:22 |
| Conductivity Ω · cm | 6.1 × 10¹ | 8.8 × 10¹ | 2.3 × 10² |
| Covering rate | 100% | 55% | 47% |

Y6 to Y8 were collected respectively to about 300 thousands decitex and then crimped and cut to 51 mm length to give staples of 3.3 decitex single yarn.

These staples were mixed with Nylon 6 staple of 3.3 decitex and 51 mm length at a mixing rate of 5 weight % to prepare a nonwoven fabric of about 180 g/m² by needle-punching and then further it was embossed to give Cloths 6 to 8. Various properties of Cloths 6 to 8 are shown in Table 4.

TABLE 4

| | Example 4 | Example 5 | Comp. Ex. 3 |
|---|---|---|---|
| Conductive yarn used | Y6 | Y7 | Y8 |
| Initial | | | |
| Surface resistance Ω | 1.1 × 10⁷ | 8.7 × 10⁶ | 3.8 × 10¹¹ |
| Antistaticity V | 2,340 | 2,200 | 2,570 |
| After 100 washings | | | |
| Surface resistance Ω | 2.3 × 10⁷ | 3.1 × 10⁷ | 2.6 × 10¹² |
| Antistaticity V | 2,090 | 2,450 | 2,550 |

As apparent from Table 4, Comparative Example 3 gave a sufficient effect in antistaticity and its durability, but the amount of scatter in surface resistance data was large and no stable effect was observed. The reason was supposed because the complex ratio of the conductive component was small and the conductive component was lowly exposed on the fiber surface.

Also, when working shoes where the nonwoven fabric of the present invention were used as the shoe inner layer and a conductive treatment was given to the sole portion were worn, static electricity accumulated in human body was leaked through the shoes to reduce static voltage in human body.

### Examples 6 to 8, Comparative Examples 4 and 5·

Cloths 9 to 13 were prepared by the same method as in Example 4 except that the mixing rate of the said Y6 was changed. The properties of the resultant nonwoven fabrics are shown in Table 5. ·

TABLE 5

| | | | | Comp. | Comp. |
|---|---|---|---|---|---|
| | Example 6 | Example 7 | Example 8 | Ex. 4 | Ex. 5 |
| Mixing rate | 0.2% | 8.5% | 14.5% | 0.05% | 20.0% |
| Initial | | | | | |
| Surface | 2.4 × 10⁸ | 2.8 × 10⁷ | 6.0 × 10⁶ | 4.3 × 10¹³ | 6.6 × 10⁶ |
| resis- | | | | | |
| tance Ω | | | | | |
| Antista- | 3,420 | 1,710 | 1,480 | 12,900 | 1,550 |
| ticity V | | | | | |

As apparent from Table 5, in Examples 6 to 8, surface resistance and an tistaticity showed a tendency of coming higher in compliance with increased mixing rate of conductive composite fibers to give sufficient results in all cases. On the other hand, the mixing rate was low in Comparative Example 4 to give no effect in both surface resistance and antistaticity. Also, surface resistance and antistaticity are saturated and thus the conductive composite fibers are thought to be present excessively in Comparative Example 5. Here, the processability and properties as a nonwoven fabric showed especially no problem but it was not so low in cost.

### Example 9·

Polyethylene terephthalate filament nonwoven fabric prepared by known melt blow process was embossed to prepare a nonwoven fabric of about 75 g/m². Two conductive composite fibers mentioned above Y2 was doubled and twisted with a polyester filament yarn of 44 decitex/18 filaments at an S twist of 600 T/m and then at a Z twist of 480 T/m to give a sewing yarn. It was sewed to the above nonwoven fabric in 5 mm intervals to the width direction of the nonwoven fabric to give Cloth 14. The Cloth had a surface resistance of 4.7×10⁷ Ω and an antistaticity of 2,110 V to show good results.

Also, the performance of the Cloth showed no deterioration even after 100 washings and a sufficient antistatitity was exerted when used as a filter.

### Industrial Utility

Textile products excellent in conductivity and its durability could be obtained according to the present invention. ·

1. A fiber complex where conductive composite fibers having a conductive thermoplastic component and a fiber forming component are mixed, characterized in that the conductive composite fiber is composed of a thermoplastic polymer containing carbon black and has a specific resistance of 10⁶ Ω cm or less, and the conductive thermoplastic component covers 50% or more of the fiber surface and has a structure continuous in the long axis direction of fiber.

2. The fiber complex according to claim 1 containing 0.1 to 15 weight % of the conductive composite fibers. ·

3. A dustproof cloth consisting of the fiber complex according to claim 1 or 2. ·

4. A shoe inner layer consisting of the fiber complex according to claim 1 or 2.

5. A filter consisting of the fiber complex according to claim 1 or 2.
